(19) United States
(12) Patent Application Publication
(10) Pub. No.: US 2014/0210768 A1
(43) Pub. Date: Jul. 31, 2014

(54) Single Layer Touch Sensor

(71) Applicant: Broadcom Corporation, Irvine, CA (US)

(72) Inventors: Massoud Badaye, Sunnyvale, CA (US); Sumant Ranganathan, Saratoga, CA (US)

(73) Assignee: INTERNATIONAL RECTIFIER CORPORATION

(21) Appl. No.: 13/937,576

(22) Filed: Jul. 9, 2013

Related U.S. Application Data
(60) Provisional application No. 61/759,339, filed on Jan. 31, 2013.

(51) Int. Cl. G06F 3/044

(52) U.S. Cl. CPC G06F 3/044
USPC 345/174

(57) ABSTRACT

According to an exemplary implementation, a touch sensor includes a plurality of traces situated between first and second columns of transmitter pads on a substrate. Each trace in the plurality of traces is routed from one extremity of the substrate and ends at a corresponding transmitter pad thereby creating an available area between the first and second columns of transmitter pads for one or more remaining traces of the plurality of traces. In some implementations, for at least one trace in the plurality of traces, each of the one or more remaining traces have an expanded width in the available area. Furthermore, at least one dummy pad can be situated in the available area for at least one trace in the plurality of traces.

The present application claims the benefit of and priority to a pending provisional application entitled “Pattern for True Single Layer Stack Up,” Ser. No. 61/759,339 filed on Jan. 31, 2013. The disclosure in this pending provisional application is hereby incorporated fully by reference into the present application.

### BACKGROUND

Touch sensors are becoming increasingly popular as input devices for electronics. Touch sensitive displays in particular have become prevalent in the marketplace. Touch sensitive displays allow a user to provide touch input over a display utilizing a finger or stylus. The touch sensitive display can provide the touch input including a touch along with a position of the touch to an electric device. The electronic device can interpret the touch input and perform an action based on the touch input. It is becoming increasingly desirable for a touch sensor to support multi-touch. The touch sensor should be configured to provide sufficient touch input resolution while avoiding significant cross coupling, which could reduce the accuracy of touch input.

### SUMMARY

A single layer touch sensor, substantially as shown in and/or described in connection with at least one of the figures, and as set forth more completely in the claims.

### BRIEF DESCRIPTION OF THE DRAWINGS

FIG. 1 presents an exemplary cross-sectional view of a portion of a touch sensor, in accordance with implementations of the present disclosure.

FIG. 2A presents an exemplary top view of a portion of a touch sensor, in accordance with implementations of the present disclosure.

FIG. 2B presents an exemplary top view of a portion of a touch sensor, in accordance with implementations of the present disclosure.

FIG. 2C presents an exemplary top view of a portion of a touch sensor, in accordance with implementations of the present disclosure.

FIG. 3A presents an exemplary top view of a portion of a touch sensor, in accordance with implementations of the present disclosure.

FIG. 3B presents an exemplary top view of a portion of a touch sensor, in accordance with implementations of the present disclosure.

FIG. 3C presents an exemplary top view of a portion of a touch sensor, in accordance with implementations of the present disclosure.

FIG. 4 presents an exemplary top view of a portion of a touch sensor, in accordance with implementations of the present disclosure.

FIG. 5 presents an exemplary top view of a portion of a touch sensor, in accordance with implementations of the present disclosure.

FIG. 6 presents an exemplary top view of a portion of a touch sensor, in accordance with implementations of the present disclosure.

FIG. 7 presents an exemplary top view of a portion of a touch sensor, in accordance with implementations of the present disclosure.

FIG. 8A presents an exemplary top view of a portion of a touch sensor, in accordance with implementations of the present disclosure.

FIG. 8B presents an exemplary cross-sectional view of a portion of a touch sensor, in accordance with implementations of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

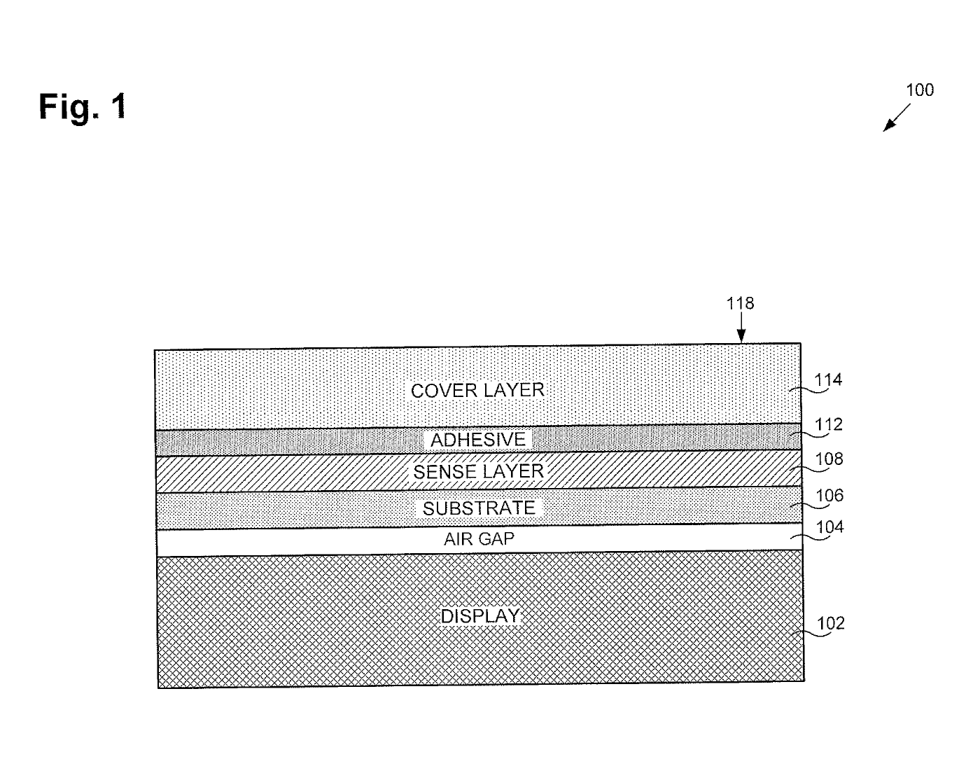

FIG. 1 presents an exemplary cross-sectional view of a portion of a touch sensor, in accordance with implementations of the present disclosure. In FIG. 1, touch sensor 100 includes display 102, air gap 104, substrate 106, sense layer 108, adhesive 112, and cover layer 114.

In the present implementation, touch sensor 100 is a touch sensitive display. Thus, touch sensor 100 includes display 102, which can be a liquid crystal display or other type of display. However, touch sensor 100 need not be a touch sensitive display and therefore display 102 may not be included in all implementations of the present disclosure. Touch sensor 100 is a single layer sensor configured to capacitively sense touch input on topside 118 of touch sensor 100 through cover layer 114. In some implementations, such as where touch sensor 100 is a touch sensitive display, it may be desirable for cover layer 114 to include transparent material. For example, cover layer 114 can be glass, plastic, or other transparent material. Cover layer 114 is adhered to sense layer 108 by adhesive 112.

In the present implementation, adhesive 112 is an optically clear adhesive (OCA) so as to not obscure visual perception of display 102.

In touch sensor 100, air gap 104 is separating display 102 from substrate 106. As with cover layer 114, it may be desirable for substrate 106 to include transparent material. For example, substrate 106 can be glass, plastic, or other transparent material. However in non-transparent touch sensors, substrate 106 need not include transparent material. In the present implementation, substrate 106 is a film substrate, such as polyethylene terephthalate (PET).

Sense layer 108 is situated on substrate 106 and includes transmitter pads and receiver electrodes configured to capacitively sense touch input from topside 118 of touch sensor 100. Sense layer 108 further includes traces configured to rout the touch input from the transmitter pads and receiver electrodes. Sense layer 108 includes conductive material, such as metal (e.g. silver) or metal alloy. Sense layer 108 can include transparent conductive material in addition to or instead of non-transparent conductive material. In the present implementation, sense layer 108 includes indium tin oxide (ITO), which is a transparent conductive material. The ITO is situated over display 102, which is unobscured due to the ITO's substantially transparent nature. The ITO can be formed on substrate 106 utilizing sputtering or other thin film deposition techniques.

The cost of a touch sensor may generally increase linearly with the number of layers used in the touch sensor. As touch sensor 100 is a single layer sensor, the cost associated with additional layers can advantageously be avoided. However, utilizing a single layer sensor can introduce various challenges. For example, it may be difficult to provide a single layer sensor that supports multi-touch with sufficient touch input resolution while avoiding significant cross coupling. As such, all known touch sensors that support multi-touch are multi-layer sensors.

Furthermore, it may be desirable to utilize low cost materials, such as PET for substrate 106 and ITO for sense layer 108. However, traces made from ITO on PET may have high resistivity compared to other materials. Utilizing wider traces can lower the trace resistance, but may expand routing zones of the touch sensor, which can be detrimental to performance of the touch sensor. Advantageously, implementations of the present disclosure provide for a single layer sensor that supports multi-touch while maintaining high performance. The high performance can be maintained even in implementations where PET is utilized for substrate 106 and ITO is utilized for sense layer 108.

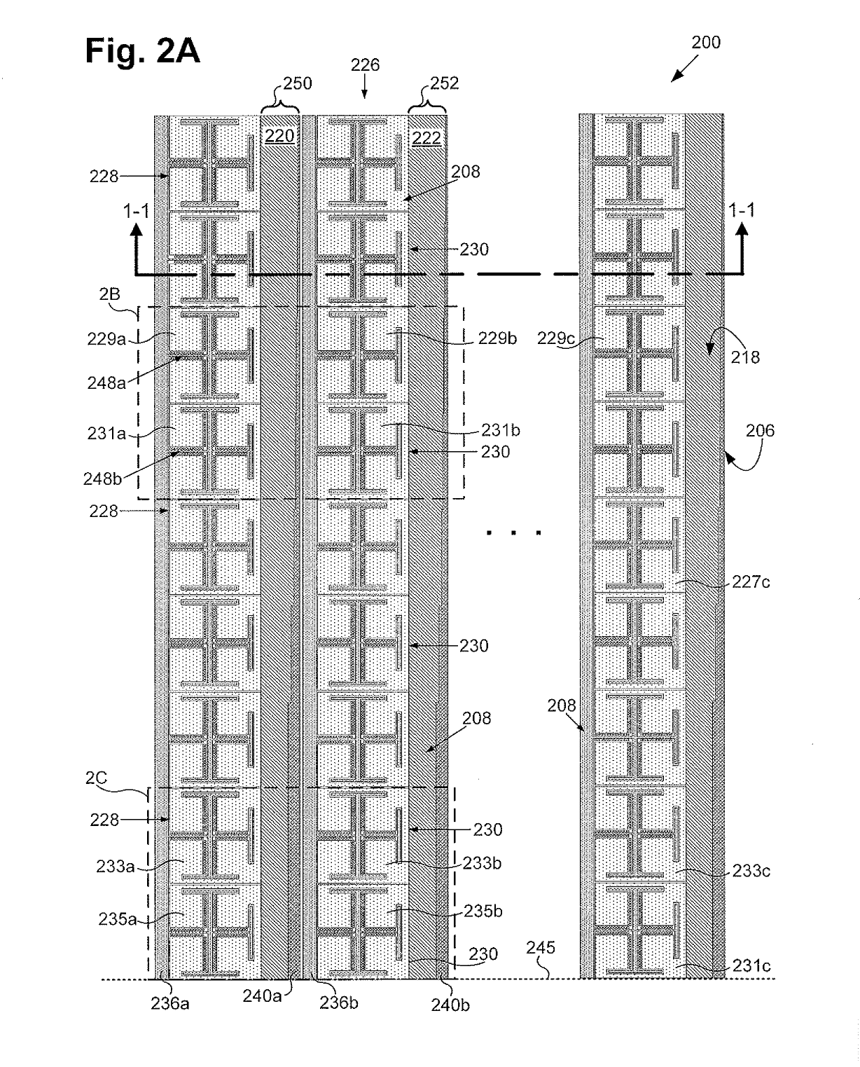

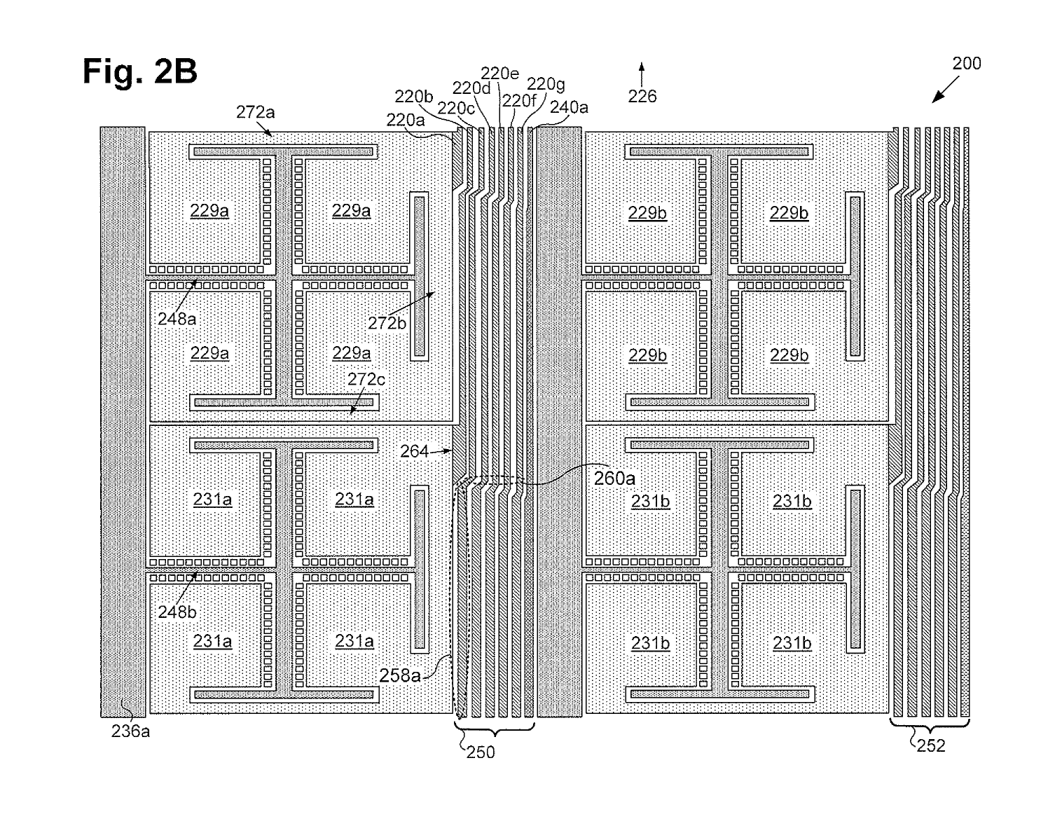

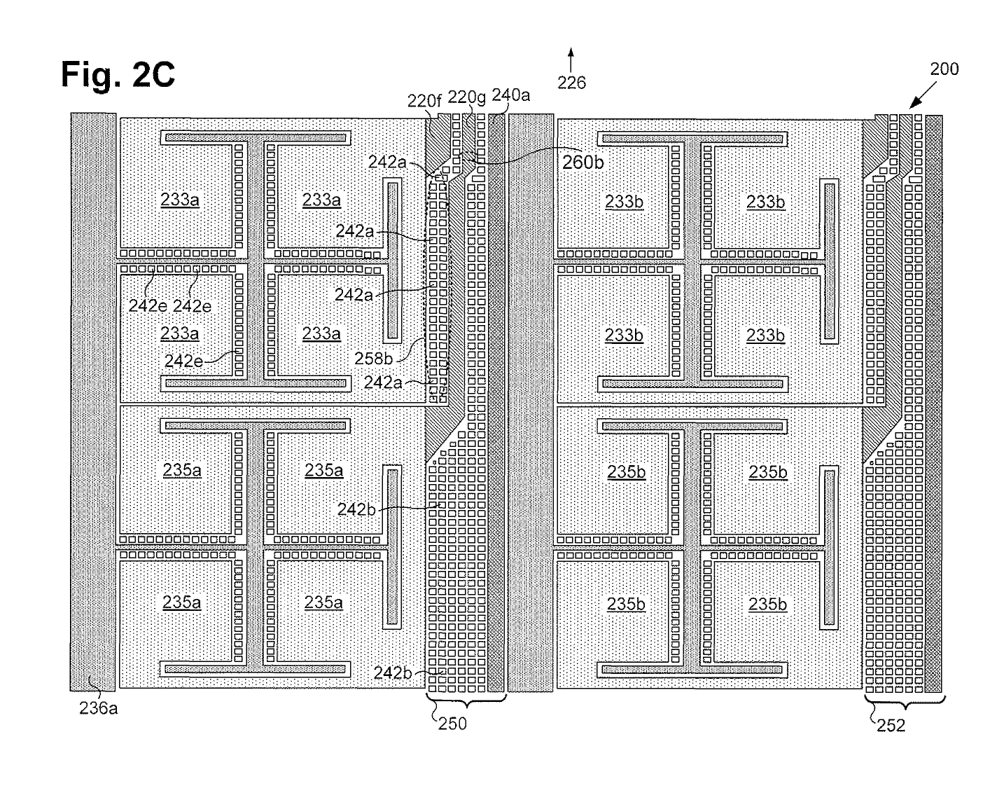

Referring now to FIGS. 2A, 2B, and 2C, FIGS. 2A, 2B, and 2C present exemplary top views of portions of a touch sensor, in accordance with implementations of the present disclosure. FIG. 2A presents an overview of touch sensor 200 and additional structural detail of touch sensor 200 is later shown and described with respect to FIGS. 2B and 2C. Touch sensor 200 corresponds to touch sensor 100 in FIG. 1. Sense layer 208 in FIGS. 2A, 2B, and 2C corresponds to sense layer 108 in FIG. 1 and substrate 206 in FIGS. 2A, 2B, and 2C corresponds to substrate 106 in FIG. 1. Cross-section 1-1 in FIG. 2A corresponds to the cross-sectional view shown in FIG. 1.

Sense layer 208 is situated on substrate 206 and includes pluralities of traces 220 and 222, columns of transmitter pads 228 and 230, receiver electrodes 236a and 236b, and ground electrodes 240a and 240b. FIG. 2A shows nine transmitter pads in column of transmitter pads 228, of which transmitter pads 229a, 231a, 233a, and 235a are individually labeled. FIG. 2A also shows nine transmitter pads in column of transmitter pads 230, of which transmitter pads 229b, 231b, 233b, and 235b are individually labeled.

In FIG. 2A, columns of transmitter pads 228 and 230 correspond to respective columns of transmitter pads in an array arrangement of rows and columns of transmitter pads. The number of rows and columns in the array arrangement can vary widely from what is shown. Furthermore, as indicated by ellipsis, features shown in FIG. 2A may be repeated.

In touch sensor 200, each receiver electrode has branching elements interdigitated with a respective column of transmitter pads. For example, receiver electrode 236a has branching elements, such as branching elements 248a and 248b, interdigitated with column of transmitter pads 228. Transmitter pads (e.g. columns of transmitter pads 228 and 230) and receiver electrodes (e.g. receiver electrodes 236a and 236b) are configured to cooperatively sense capacitive touch input from topside 218 of touch sensor 200. Traces (e.g. pluralities of traces 220 and 222) are configured to rout the touch input from the transmitter pads and receiver electrodes.

Touch sensor 200 is configured to support multi-touch (i.e. contemporaneous touches). For each row of transmitter pads in touch sensor 200, the transmitter pads of a respective row of transmitter pads can be electrically connected to one another. For example, in FIG. 2A, transmitter pads 229a, 229b, and 229c are in a common row of transmitter pads and can be electrically connected to one another. Similarly, transmitter pads 233a, 233b, and 233c are in another common row of transmitter pads that can be electrically connected to one another.

In various implementations, the respective row of transmitter pads can be electrically connected to one another in touch sensor 200 or external to touch sensor 200. In the implementation shown, the transmitter pads of the respective row of transmitter pads are coupled together via respective traces at a flex circuit (not shown). This may be accomplished utilizing a multi-layer flex circuit. In contrast, the transmitter pads within each column of transmitter pads in touch sensor 200 are substantially electrically isolated from one another. As an example, transmitter pads 229a, 231a, 233a, and 235a are substantially electrically isolated from one another in column of transmitter pads 228.

Areas of sense layer 208, which are not significantly receptive to touch input are referred to as routing zones and may be utilized for electrical routing. Routing zone 250 between columns of transmitter pads 228 and 230 will be described in detail herein. However, each similar area between adjacent columns of transmitter pads in touch sensor 200 (e.g. routing zone 252) is structured substantially similar to routing zone 250. Routing zone 250 includes plurality of traces 220 and ground electrode 240a. Routing zone 250 can also include at least one dummy pad, as will be described in further detail below.

In routing zone 250, ground electrode 240a is situated between column of transmitter pads 228 and column of transmitter pads 230. Ground electrode 240a is routed from extremity 226 of substrate 206 and is configured to insulate plurality of traces 220 and receiver electrode 236b, which is adjacent and neighboring plurality of traces 220. Plurality of traces 220 is also situated between columns of transmitter pads 228 and 230 on substrate 206. Each trace (also referred to herein as a “terminating trace”) in plurality of traces 220 is routed from extremity 226 of substrate 206 and ends at a corresponding transmitter pad. In the present implementation, the corresponding transmitter pad is of column of transmitter pads 228, however in other implementations, the corresponding transmitter pad can be of column of transmitter pads 230 or other transmitter pads in touch sensor 200. Thus, plurality of traces 220 are configured to rout capacitive touch input from the corresponding transmitter pad to extremity 226 of substrate 206, which includes a flex circuit (not shown) for external connection to touch sensor 200.

In a touch sensor it may be challenging to provide electrical routing without impacting performance of the touch sensor. For a single layer sensor in particular, area utilized for the electrical routing can be substantial so as to provide sufficient bandwidth to the touch sensor. In touch sensor 200, routing zones utilized for the electrical routing, such as routing zones 250 and 252, are highly efficient in terms of area utilized on substrate 206 while providing high performance to touch sensor 200, including high bandwidth.

Referring to FIG. 2B with FIG. 2A, FIG. 2B corresponds to area 2B in FIG. 2A. FIG. 2B shows traces 220a, 220b, 220c, 220d, 220e, 220f, and 220g of plurality of traces 220 of FIG. 2A. Each trace in plurality of traces 220 is routed from extremity 226 of substrate 206 and ends at a corresponding transmitter pad thereby creating an available area between columns of transmitter pads 228 and 230 for one or more remaining traces of plurality of traces 220. For example, FIG. 2B shows trace 220b of plurality of traces 220, which is routed from extremity 226 of substrate 206 and ends at transmitter pad 231a. Available area 258a is thereby created between columns of transmitter pads 228 and 230 for traces 220c, 220d, 220e, 220f, and 220g of one or more remaining traces 260a of plurality of traces 220. Thus, while plurality of traces 220 includes nine traces, only seven are shown in FIG. 2B as two traces have ended at respective preceding rows of transmitter pads. Furthermore, while plurality of traces 220 includes nine traces at the first row of transmitter pads shown in FIG. 2A (closest to extremity 226), plurality of traces 220 includes one trace at the last row of transmitter pads shown in FIG. 2A (farthest from extremity 226).

In the implementation shown in FIG. 2B, one or more remaining traces 260a of plurality of traces 220 has an expanded width between columns of transmitter pads 228 and 230 provided by available area 258a. As shown, each trace in one or more remaining traces 260a has an expanded width that is accommodated by available area 258a. The expanded width of one or more remaining traces 260a of plurality of traces 220 lowers the resistance of traces 220c, 220d, 220e, 220f, and 220g thereby increasing the bandwidth of touch sensor 200.

Thus, an available area (e.g. available area 258a in FIG. 2B) is formed at each of row of transmitter pads due to a terminating trace. Expanding the width of a trace, in plurality of traces 220, increases the capacitance of the trace. This can introduce a risk of the trace coupling to other traces of plurality of traces 220, to receiver electrode 236a, or to other elements in touch sensor 200. Thus, as described in further detail below, various approaches can be employed to utilize the available area for bandwidth improvement purposes instead of or in addition to expanding the width of one or more traces in the one or more remaining traces. Those approaches may be combined in any workable manner. Furthermore, each approach may be utilized in any combination for any available area.

In the present implementation, from the first row of transmitter pads shown in FIG. 2A (closest to extremity 226) to the seventh row of transmitter pads shown in FIG. 2A, the one or more remaining traces have an expanded width in the available area, similar to what is shown in FIG. 2B. Thus, terminating traces that are farther away from extremity 226 have expanded in width more times than terminating traces that are closer to extremity 226. Expanding the width of a trace reduces the resistance of the trace. Thus, terminating traces in plurality of traces 220 that are farther away from extremity 226 are compensated for based on their distance from extremity 226, thereby maintaining bandwidth for touch sensor 200.

Below the seventh row of transmitter pads, each trace in the one or more remaining traces has a substantially fixed width. Referring to FIG. 2C with FIG. 2A, FIG. 2C corresponds to area 2C in FIG. 2A. FIG. 2C illustrates trace 220f in plurality of traces 220 being routed from extremity 226 of substrate 206 and ending at transmitter pad 233a thereby creating available area 258b between columns of transmitter pads 228 and 230 for one or more remaining traces 260b of plurality of traces 220. Trace 220g in one or more remaining traces 260b is of a substantially fixed width below the seventh row of transmitter pads in touch sensor 200. However, one or more remaining traces 260b has expanded insulative spacing within routing zone 250 between columns of transmitter pads 228 and 230. Cross coupling between adjacent traces in one or more remaining traces 260b and/or other features of touch sensor 200 can be reduced by expanding insulative spacing of one or more remaining traces 260b.

Thus, rather than or in addition to at least one of the one or one or more remaining traces having an expanded width between columns of transmitter pads, at least one of the one or more remaining traces can have expanded insulative spacing between columns of transmitter pads. In some implementations, at least one dummy pad is provided by the available area. In FIG. 2C, dummy pad area 242a includes dummy pads configured to reduce optical contrast between sense layer 208 (e.g. ITO) and voids that would have resulted if the expanded space between the traces had been left empty. In the implementation shown, dummy pad area 242a is situated in the insulative spacing of one or more remaining traces 260b and is filling available area 258c between one or more remaining traces 260b and receiver electrode 236a. Dummy pad area 242a is also situated between one or more remaining traces 260b and transmitter pad 233a.

Dummy pads of dummy pad area 242a of sense layer 208 are electrically floating (as are all other dummy pads in touch sensor 200). In the present implementation, dummy pad area 242a includes a plurality of dummy pads. The plurality of dummy pads can have various shapes and sizes. In FIG. 2C, the plurality of dummy pads includes an array arrangement of dummy pads, which are rectangular.

Thus, rather than or in addition to the approaches described above for utilizing the available area, at least one dummy pad can be provided by the available area. In touch sensor 200, dummy pad area 242a is situated in the expanded insulative spacing of one or more remaining traces 260b. Furthermore, dummy pad area 242a expands with the expanded insulative spacing as shown. The increased shielding, caused by the expanded insulative spacing, can compensate for plurality of traces 220 having increased capacitance for lower rows of the transmitter pads, while dummy pad area 242a reduces the optical contrast of the expanded insulative spacing.

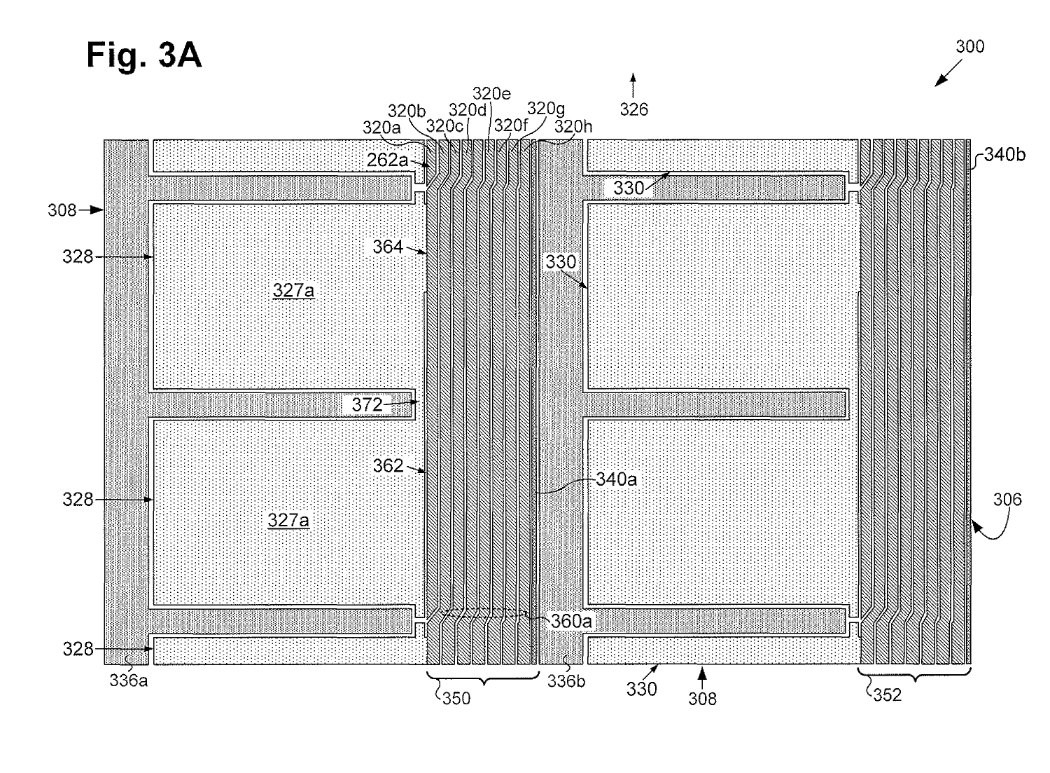

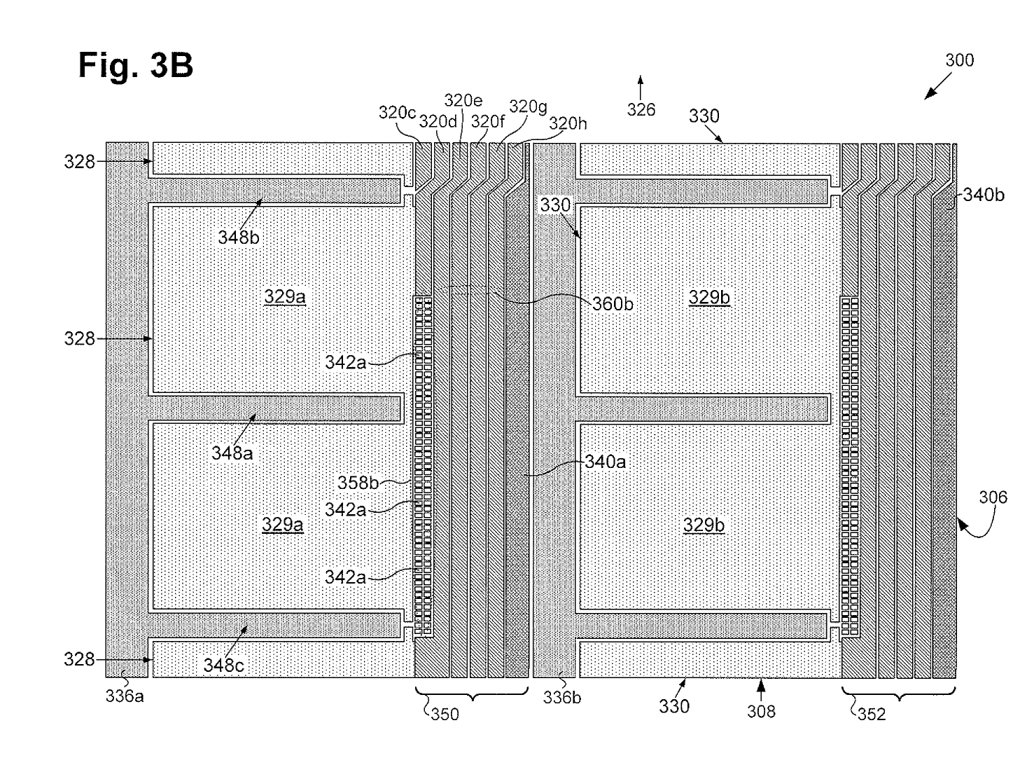

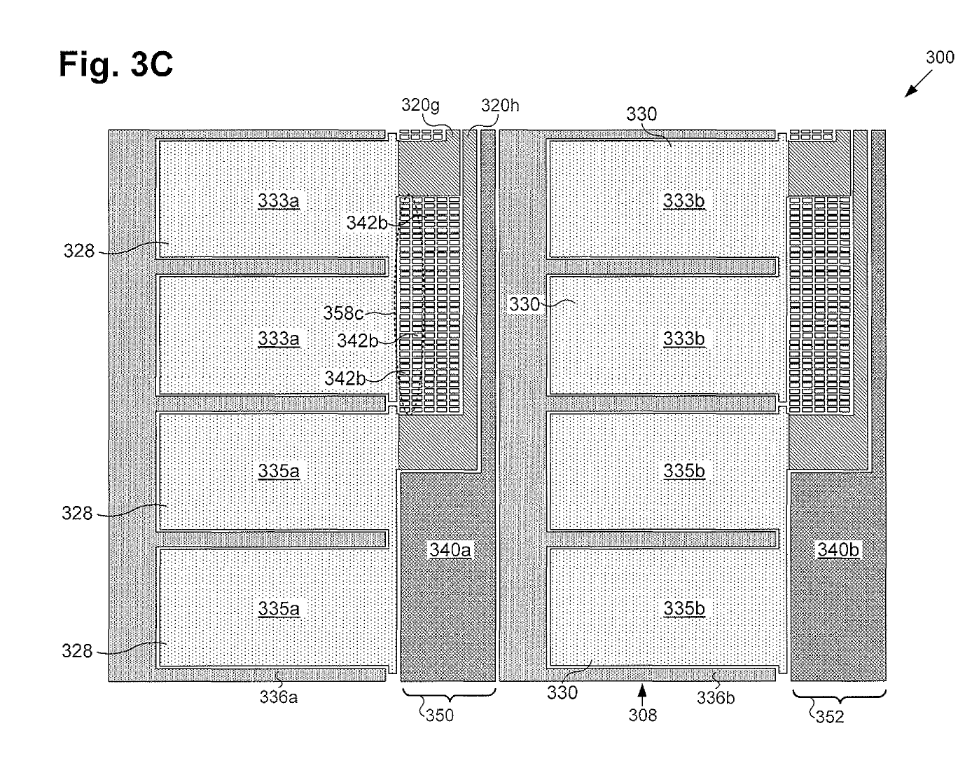

At least one dummy pad can be provided by an available area independently from utilizing expanded insulative spacing for at least one of the one or more remaining traces as exemplified in FIGS. 3B and 3C. Referring to FIGS. 3A through 3C, FIGS. 3A through 3C show a top view of portions of touch sensor 300, in accordance with alternative implementations of the present disclosure. Touch sensor 300 includes eighteen rows of transmitter pads where FIG. 3A shows the eleventh row of transmitter pads, FIG. 3B shows the fourteenth row of transmitter pads, and FIG. 3C shows the seventeenth and eighteenth rows of transmitter pads.

Touch sensor 300 includes substrate 306, sense layer 308, extremity 326, receiver electrodes 336a and 336b, columns of transmitter pads 328 and 330, and routing zones 350 and 352 corresponding to substrate 206, sense layer 208, extremity 226, receiver electrodes 236a and 236b, column of transmitter pads 228 and 230, and routing zones 250 and 252 in FIGS. 2A through 2C. Touch sensor 300 further includes traces 320a, 320b, 320c, 320d, 320e, 320f, 320g, and 320h corresponding to respective traces of plurality of traces 220 in FIG. 2A.

FIG. 3B shows dummy pad area 342a corresponding to dummy pad area 242a in FIG. 2C. Dummy pad area 342a is provided by available area 358b corresponding to available area 258b in FIG. 2C. Dummy pad area 342a is filling available area 358b. However, a dummy pad is not situated between adjacent ones of one or more remaining traces 360b, corresponding to one or more remaining traces 260b in FIG. 2C. In touch sensor 300, at least one dummy pad fills each available area in and below the row of transmitter pads that includes transmitter pads 329a and 329b. Furthermore, one or more remaining traces 360b have a substantially fixed width in and below the row of transmitter pads that includes transmitter pads 329a and 329b. FIG. 3C similarly shows dummy pad area 342b provided by available area 358c. Referring again to FIGS. 2A through 2C, in some implementations, rather than or in addition to the approaches described above for utilizing available area, the ground electrode has an expanded width provided by the available area. As shown in FIG. 2B, ground electrode 340a has an expanded width provided by available area 258a. FIG. 2A shows that ground electrode 240a has an expanded width at each row of transmitter pads in touch sensor 200 up to the seventh row of transmitter pads. Below the seventh row of transmitter pads, ground electrode 240a has a substantially fixed width. Ground electrode 240b is similarly configured as ground electrode 240a. The expanded width of ground electrode 240a reduces the resistance of ground electrode 240a thereby increasing the effectiveness of ground electrode 240a. Ground electrode 240a can have an expanded width one or more times in accordance with implementations of the present disclosure.

Thus, various approaches have been described above for utilizing the available area between first and second columns of transmitter pads in the routing zone. Thus, routing zones utilized for the electrical routing, such as routing zones 250 and 252, can be highly efficient in terms of area utilized on substrate 206 while providing high performance to touch sensor 200 including high bandwidth.

In touch sensor 200, each terminating trace ends at a respective contact region of a corresponding transmitter pad. For example, trace 220b in FIG. 2B ends at contact region 264 of transmitter pad 231a. However, each terminating trace may optionally extend past the respective contact region of the corresponding transmitter pad. As shown in FIG. 3A, for example, trace 320b includes shielding portion 362, which extends past contact region 364 of transmitter pad 327a. Shielding portion 362 is configured to shield one or more remaining traces 360a from receiver electrode 336a thereby reducing the risk of cross coupling in touch sensor 300. FIG. 3A shows shielding portion 362 situated between one or more remaining traces 360a and receiver electrode 336a. In touch sensor 300, from the first row of transmitter pads to the thirteenth row of transmitter pads, each terminating trace includes a respective shielding portion similar to what is shown in FIG. 3A.

The plurality of traces can terminate in various manners in accordance with implementations of the present disclosure. For example, as shown in FIG. 2C, in touch sensor 200, plurality of traces 220 terminates with dummy pad area 242b and ground electrode 240a in routing zone 250. As another example, FIG. 3C demonstrates termination of a trace with only with only ground electrode 340a filling the remaining area of routing zone 350. Ground electrode 340a has an expanded width in the last row of transmitter pads that are coupled to the plurality of traces routed to extremity 326. Ground electrode 340a spans routing zone 350. Utilizing such a configuration, the resistance of ground electrode 340a is reduced along with coupling between the plurality of traces and ground electrode 340a.

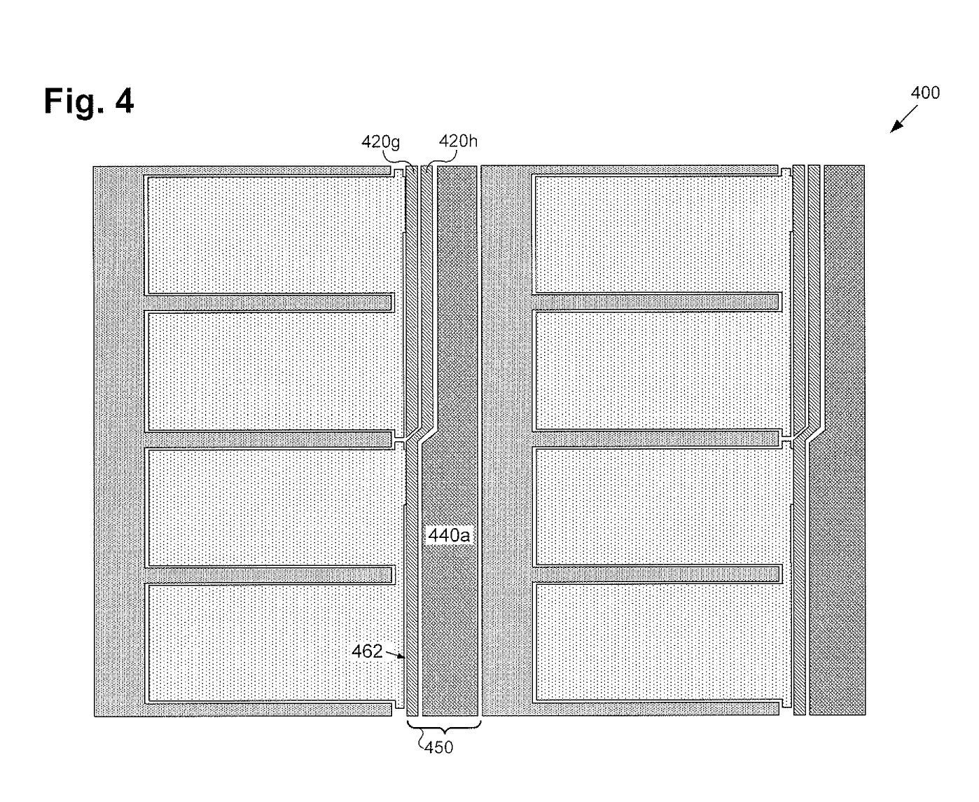

Referring now to FIG. 4, FIG. 4 presents an exemplary top view of a portion of a touch sensor, in accordance with implementations of the present disclosure. The portion of touch sensor 400 shown in FIG. 4 corresponds to the portion of touch sensor 300 shown in FIG. 3. Thus, ground electrode 440a in FIG. 4 corresponds to ground electrode 340a in FIG. 3. Also, traces 420g and 420h in FIG. 4 correspond to traces 320g and 320h in FIG. 3. Other corresponding features are similarly depicted in FIG. 4, but are not specifically labeled. Touch sensor 400 is similar to touch sensor 300, however, touch sensor 400 does not include any dummy pads like touch sensor 300. Rather, for each row of transmitter pads in touch sensor 400, the one or more remaining traces have a substantially fixed width, and ground electrode 440a has an expanded width in each available area. As shown in FIG. 4, touch sensor 400 terminates while ground electrode 440a and shielding portion 462 of trace 420h, corresponding to shielding portion 362 in FIG. 3A, fills the remaining area of routing zone 450.

The transmitter pads and the receiver electrodes utilized in touch sensors of the present disclosure can have various configurations. Each transmitter pad can be configured similar to transmitter pad 229a in FIG. 2B. Receiver electrode 236a divides transmitter pad 229a into substantially equal sections (e.g. four substantially equal sections). The substantially equal sections are rectangular, by way of example, and connecting portions 272a, 272b, and 272c couple the substantially equal sections together. Transmitter pad 229a is thus highly symmetrical. Furthermore, transmitter pad 229a completely encompasses branching element 248a of receiver electrode 236a. By completely encompassing branching element 248a, receiver electrode 236a is effectively insulated from other electrical features of touch sensor 200, such as routing zone 250.

At least one dummy pad can be situated between the transmitter pad and the receiver electrode. For example, in FIG. 2B dummy pad area 242e is situated between transmitter pad 229a and branching element 248a of receiver electrode 236a. As shown, at least one dummy pad is situated between each of the substantially equal sections and branching element 248a.

FIG. 3A shows an alternative configuration for the receiver electrodes and the transmitter pads. As shown in FIG. 3A, transmitter pad 327a has two substantially equal sections, which are rectangular by way of example. Branching element 348a (which may also be referred to as a finger in this implementation) of receiver electrode 336a divides transmitter pad 327a into the two substantially equal sections. Connecting portion 372 couples the two substantially equal sections. Also in FIG. 3A, transmitter pad 327a is separated from adjacent transmitter pads of column of transmitter pads 328 by branching elements 348b and 348c of receiver electrode 336a. The configuration of receiver electrodes and transmitter pads in touch sensor 300 may be less desirable in certain respects than the implementation utilized in touch sensor 200, but can still exhibit high performance.

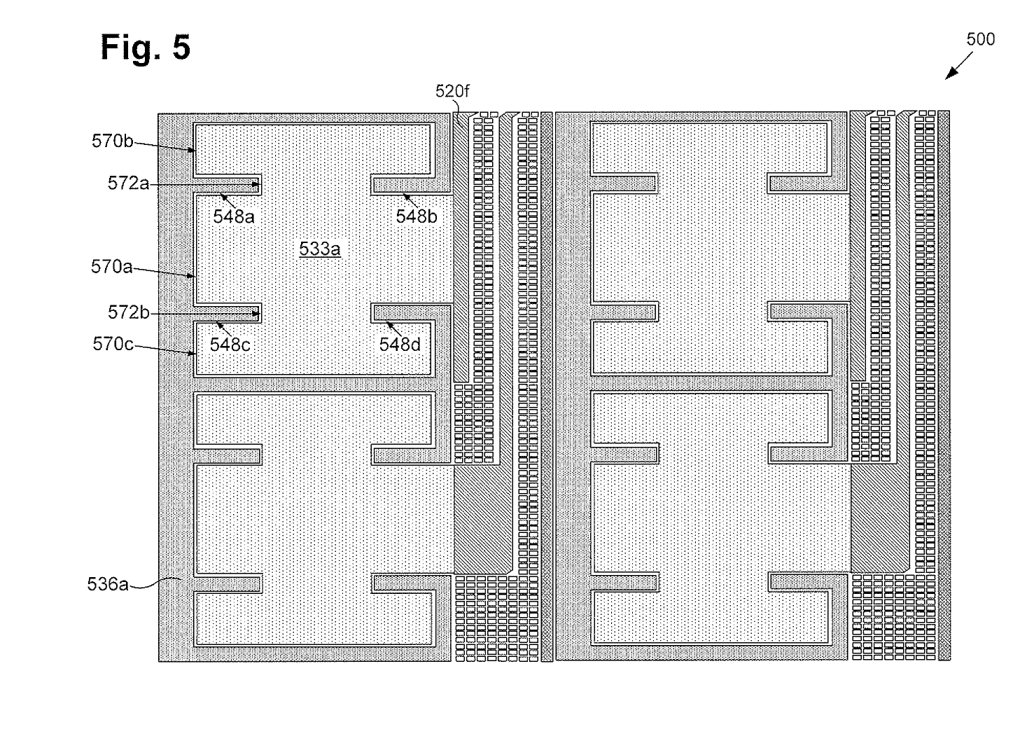

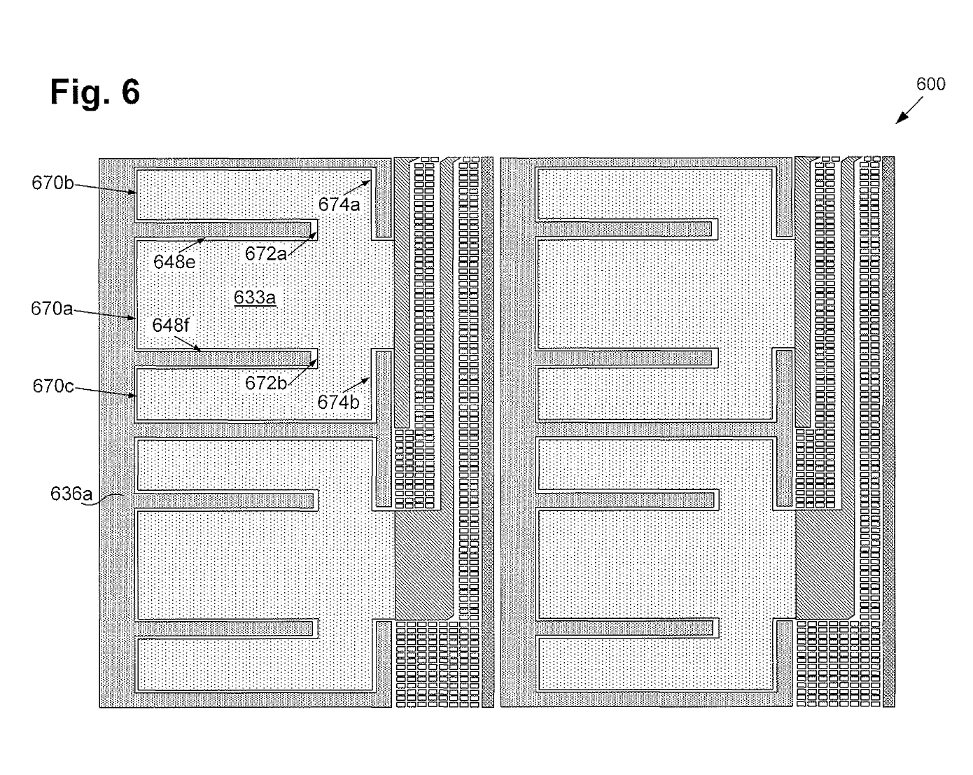

Referring now to FIGS. 5 and 6, FIGS. 5 and 6 present exemplary top views of portions of touch sensors, in accordance with another implementation of the present disclosure. The portion of touch sensor 500 shown in FIG. 5 can correspond to the portion of touch sensor 200 shown in FIG. 2C. The portion of touch sensor 600 shown in FIG. 6 can also correspond to the portion of touch sensor 200 shown in FIG. 2C.

Referring now to FIG. 5, FIG. 5 shows transmitter pad 533a, receiver electrode 536a, and trace 520f corresponding to transmitter pad 233a, receiver electrode 236a, and trace 220f in FIG. 2C. In FIG. 5, transmitter pad 533a has central section 570a and peripheral sections 570b and 570c. Peripheral sections 570b and 570c surround central section 570a and are coupled to trace 520f through central section 570a, which connects to trace 520f. Receiver electrode 536a divides transmitter pad 533a into central section 570a and peripheral sections 570b and 570c. More particularly, branching elements 548a, 548b, 548c, and 548d of receiver electrode 536a define central section 570a and peripheral sections 570b and 570c. Connecting portion 572a couples central section 570a and peripheral section 570b. Connecting portion 572b couples central section 570a and peripheral section 570c. Connecting portions 572a and 572b are narrower than central section 570a and peripheral sections 570b and 570b. Each transmitter pad and receiver electrode in touch sensor 500 can similarly be configured.

Touch sensor 600 in FIG. 6 is similar to touch sensor 500 in FIG. 5, except for differences described below with respect to the configuration of the transmitter pads and receiver electrodes. In FIG. 6, connecting portions 672a and 672b are at edges 674a and 674b of peripheral pads 670b and 670c. Thus, in FIG. 6, central pad 670a and peripheral pads 670b and 670c are defined by and separated by branching elements s 648e and 648f of receiver electrode 636a. Each transmitter pad and receiver electrode in touch sensor 600 can similarly be configured.

The transmitter pads in touch sensors 500 and 600 are more symmetrical than transmitter pad 327a in touch sensor 300. The configuration of receiver electrodes and transmitter pads in touch sensors 500 and 600 may be less desirable in certain respects than the implementation utilized in touch sensor 200, but can still exhibit high performance.

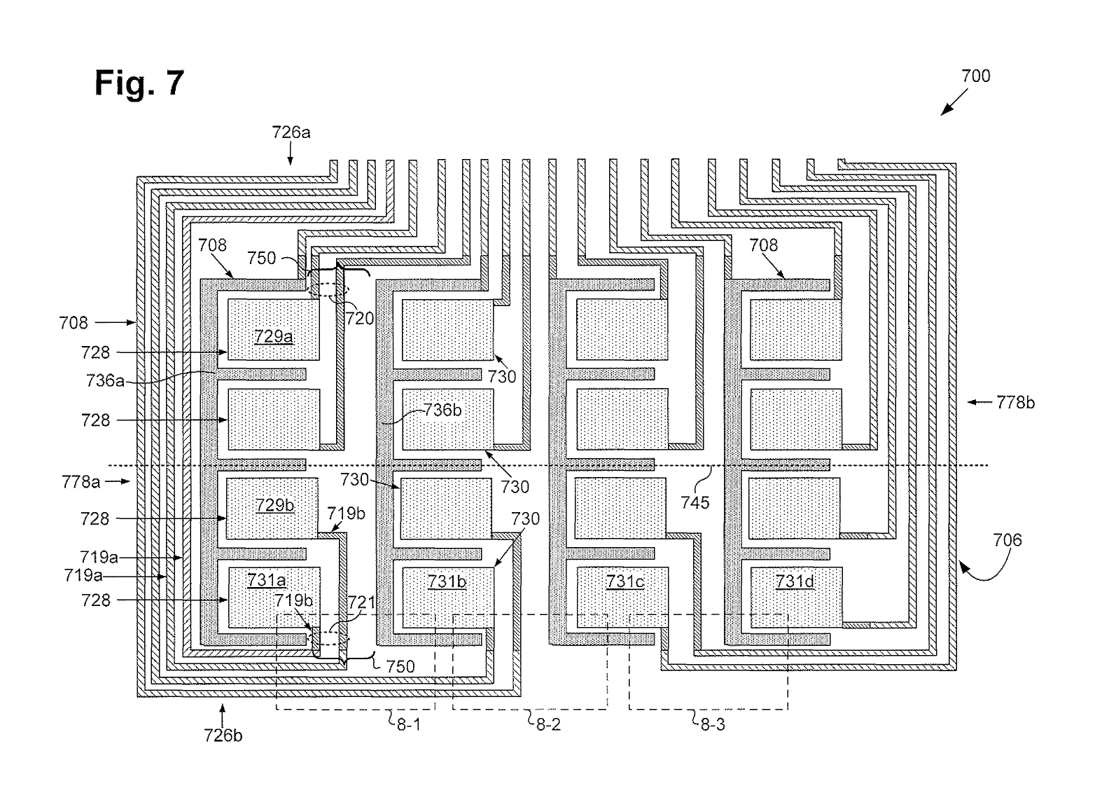

Referring now to FIG. 7, FIG. 7 presents an exemplary top view of a portion of a touch sensor, in accordance with implementations of the present disclosure. In FIG. 7, touch sensor 700 can correspond any of the various touch sensors described above. Touch sensor 700 includes sense layer 708 and substrate 706 corresponding respectively to sense layer 208 and substrate 206 of touch sensor 200. Sense layer 708 includes column of transmitter pads 728 and 730, receiver electrodes 736a and 736b, and routing zone 750 corresponding respectively to column of transmitter pads 228 and 230, receiver electrode, and routing zone 250 in sense layer 208.

Touch sensor 700 includes upper plurality of traces 720 situated between columns of transmitter pads 728 and 730 on substrate 706. Each trace in upper plurality of traces 720 is routed from extremity 726a of substrate 706 and ends at a corresponding upper transmitter pad (e.g. upper transmitter pad 729a), similar to plurality of traces 220 in touch sensor 200. Touch sensor 700 also includes lower plurality of traces 721 situated between columns of transmitter pads 728 and 730 on substrate 706. Each trace in lower plurality of traces 721 is routed from extremity 726b of substrate 706 and ends at a corresponding lower transmitter pad (e.g. lower transmitter pad 731a). The total number of traces for touch sensor 700 can thereby be divided amongst upper plurality of traces 720 and lower plurality of traces 721. Thus, the number of traces across the width of routing zone 750 can be reduced, providing significant flexibility in configuring routing zone 750. For example, routing zone 750 can be smaller than a routing zone where all traces are routed directly from extremity 726a while providing similar or higher bandwidth to touch sensor 700.

In the implementation shown, extremity 726a of substrate 706 is opposite extremity 726b of substrate 706. Lower plurality of traces 721 are routed from extremity 726b to a corresponding lower transmitter pad. Also, lower plurality of traces 721 are further optionally routed from extremity 726a to extremity 726b of substrate 706, as shown in FIG. 7. Thus, plurality of traces 720 and lower plurality of traces 721 can each be provided to a common extremity, extremity 726a, of substrate 706. At extremity 726a, upper and lower plurality of traces 720 and 721 can be connected to a flex circuit similar to what has been described above with respect to plurality of traces 220 in touch sensor 200.

In some implementations, for at least some of the columns of transmitter pads, the routing zone is structurally mirrored at a central portion of the routing zone. For example, in touch sensor 700, routing zone 750 can be structurally mirrored at central portion 745 of routing zone 750. FIG. 2A shows central portion 245 corresponding to central portion 745 in FIG. 7. Each structural detail shown above central portion 245 may be mirrored below central portion 245. Thus, touch sensor 200 can have eighteen rows of transmitter pads without substantially reducing bandwidth.

In touch sensor 700, lower plurality of traces 721 includes section 719a situated outside of columns of transmitter pads 728 and 730. Section 719a is distinguished from section 719b of lower plurality of trace 721 by different shading in FIG. 7. Section 719a of lower plurality of traces 721 is optionally made of material that is more conductive than section 719b of lower plurality of traces 721, which is situated between columns of transmitter pads 728 and 730. Lower plurality of traces 721 can thereby maintain high bandwidth in touch sensor 700. For example, the bandwidth provided by lower plurality of traces 721 can be substantially matched to the bandwidth provided by plurality of traces 720 despite traveling a longer distance to extremity 726a.

Section 719h, of lower plurality of traces 721 can include transparent conductive material, such as ITO, so as to not obscure a display under substrate 706. Section 719a of plurality of traces 720b can include non-transparent conductive material, such as metal (e.g. silver) or metal alloy. As section 719a is around the peripheral of touch sensor 700, section 719a can easily be configured so as to not obscure any display that may be provided thereunder. Also, section 719a of lower plurality of traces 721 may be situated beneath a bezel of touch sensor 700. It is noted that either of sections 719a and 719b can include transparent conductive material or non-transparent conductive material in accordance with implementations of the present disclosure.

Other features similar to upper and lower plurality of traces 720 and 721 are similarly depicted in FIG. 7. Lower plurality of traces 721 and similarly configured features can wrap around columns of transmitter pads 728 and 730 on either of sides 778a and 778b of substrate 706. It may be desirable to rout some of the plurality of traces to sides 778a and others of the plurality of traces to side 778b, as shown, so as to reduce routing distance, and to minimize bezel width used for routing vertical traces. It should be noted that FIG. 7 is simplified from previous features so as to not obscure aspects of the present disclosure being described. For example, FIG. 7 does not specifically show a feature corresponding to ground electrode 240a in touch sensor 200, however, one or more ground electrodes may extend alongside upper and lower plurality of traces 720 and 721 from extremity 726a of substrate 706. The one or more ground electrodes may also optionally wrap around the peripheral of touch sensor 700.

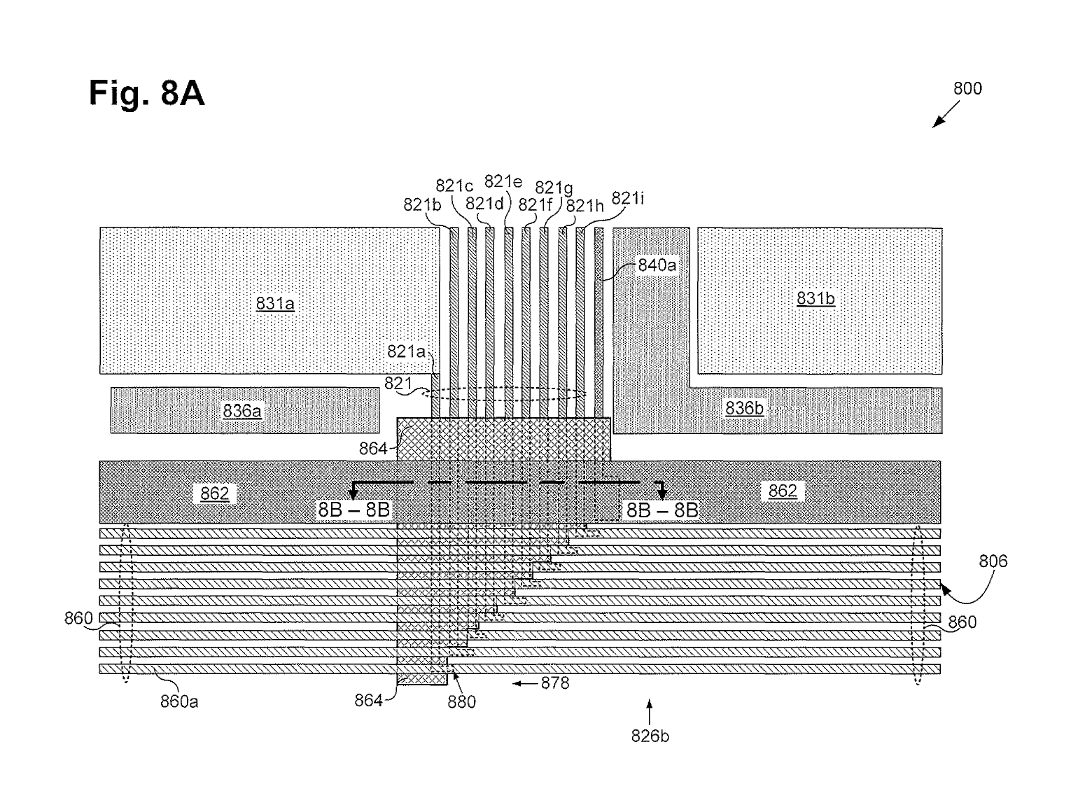

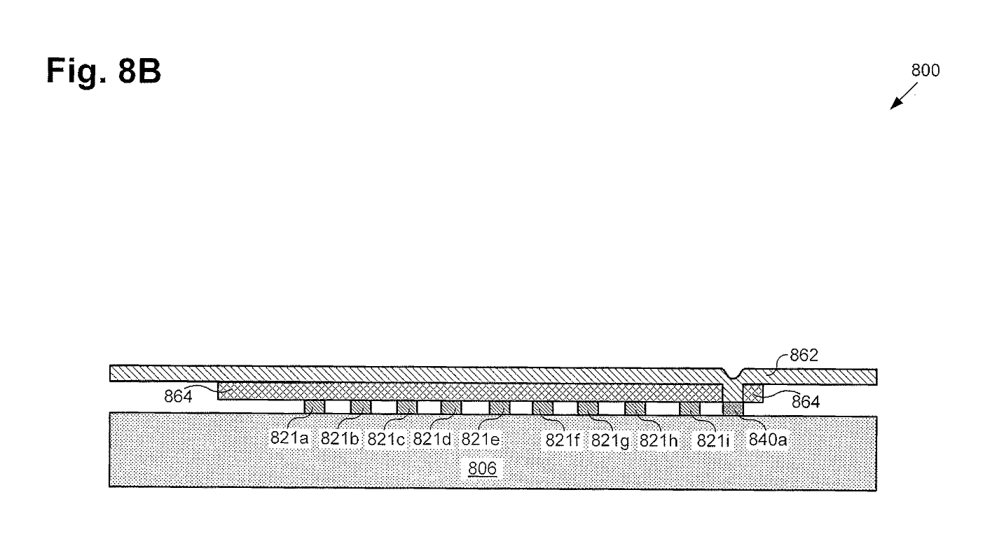

As shown in FIG. 7, a number of traces may be routed so as to wrap around columns of transmitter pads 728 and 730 on either of sides 778a and 778b of substrate 706. As the number of transmitter pads in touch sensor 700 increases, significant area of substrate 706 may be utilized for routing the traces outside of the columns of transmitter pads. In some implementations, traces corresponding to respective transmitter pads of a common row of transmitter pads are coupled into a combined trace at extremity 726b of substrate 706 (not shown in FIG. 7). For example, respective traces from transmitter pads 731a, 731b, 731c, and 731d can be coupled into a single trace, which then may be routed to extremity 726a of substrate 706. The combined trace, or single trace, may correspond to section 719a of lower plurality of traces 721 or other similar sections in FIG. 7. Furthermore, the combined trace, or single trace, can include similar materials as section 719a. A similar approach may be utilized for any other rows of transmitter pads. FIGS. 8A and 8B shows one approach to coupling the traces into a combined trace, however other approaches may be employed.

Referring now to FIGS. 8A and 8B, FIG. 8A presents an exemplary top view of a portion of a touch sensor, in accordance with implementations of the present disclosure.

FIG. 8B presents an exemplary cross-sectional view of a portion of a touch sensor, in accordance with implementations of the present disclosure. Cross-section 8B-8B in FIG. 8A corresponds to the cross-sectional view shown in FIG. 8B.

FIGS. 8A and 8B show touch sensor 800, which can correspond to an implementation of touch sensor 700 where lower plurality of traces 721 includes nine traces coupled to nine respective transmitter pads as opposed to the two traces shown in FIG. 7. Furthermore, as opposed to what is shown in FIG. 7, each area 8-1, 8-2, and 8-3 in FIG. 7 can be similar to FIG. 8A so that traces corresponding to a common row of transmitter pads are coupled into a single trace as described above.

Touch sensor 800 includes plurality of traces 821, receiver electrodes 836a and 836b, transmitter pads 831a and 831b, and substrate 806 corresponding to lower plurality of traces 721, receiver electrodes 736a and 736b, transmitter pads 731a and 731b, and substrate 706 in FIG. 7. Plurality of traces 821 includes traces 821a, 821b, 821c, 821d, 821e, 821f, 821g, 821h, and 821i. Touch sensor 800 also includes ground electrode 840a corresponding to ground electrode 240a in touch sensor 200. Touch sensor 800 further includes combined traces 860, optionally combined ground 862, and insulation patch 864.

As shown in FIG. 8B, insulation patch 864 is situated over plurality of traces 821 and ground electrode 840a. Portions of plurality of traces 821 and ground electrode 840a that are covered by insulation patch 864 in FIG. 8A are indicated using dashed lines. Combined traces 860 and combined ground 862 are situated over insulation patch 864. Insulation patch 864 includes dielectric material (e.g. printed dielectric material) so as to insulate some of combined traces 860 and combined ground 862 from plurality of traces 821 and ground electrode 840a.

Plurality of traces 821 and ground electrode 840a may be printed on substrate 806 followed by printing insulation patch 864 over portions thereof. Finally, combined traces 860 and combined ground 862 may be printed over insulation patch 864, plurality of traces 821, and ground electrode 840a. Exposed portions of plurality of traces 821 and ground electrode 840a are electrically connected to combined traces 860 and combined ground 862 by the printing of combined traces 860 and combined ground 862.

By utilizing insulation patch 864, some of plurality of traces 821 may traverse some of combined traces 860 and combined ground 862 so that each trace in plurality of traces 821 is electrically connected to a respective one of combined traces 860. For example, trace 821a is electrically connected to combined trace 860a without being electrically connected to others of combined traces 860 or combined ground 862.

In FIG. 8A, insulation patch 864 has a step structure at side 878, where each step of the step structure corresponds to one of combined traces 860 or to combined ground 862. Each trace of plurality of traces 821 and ground electrode 840 includes a contact region, which optionally bends to extend under a respective one of combined traces 860 or combined ground 862, as shown. For example, trace 821a includes contact region 880, which extends under combined trace 860a and is substantially parallel to combined trace 860a. Contact region 880 extends out from under insulation patch 864 at a respective step of the step structure to thereby electrically connect to combined trace 860a. Each other one of plurality of traces 821 and ground electrode 840a is similarly structured.

By bending to extend under a respective one of combined traces 860, the contact regions increase contact area with the respective one of combined traces 860 or combined ground 862. In some implementations, each trace in plurality of traces 821 electrically connects to a respective one of combined traces 860 through a respective via hole in insulation patch 864. In some implementations, filling via holes in insulation patch 864 with combined traces 860 may cause problems; especially where ink used to print combined traces 860 is viscous. By electrically connecting plurality of traces 821 to combined traces 860 at one or more sides of insulation patch 864 (e.g. at side 878 as shown), the via holes in insulation patch 864 can be avoided.

As described above, each area 8-1, 8-2, and 8-3 in FIG. 7 can be similar to FIG. 8A so that for each row of transmitter pads in touch sensor 700, traces corresponding to respective transmitter pads of a common row of transmitter pads are coupled into a combined trace at extremity 726b of substrate 706. Routing the combined traces to extremity 726a can significantly reduce the number of traces being routing from extremity 726b to extremity 726a. Using a combined ground may serve a similar function for ground electrodes of respective routing zones in touch sensor 700. Thus, sense layer 708 can consume significantly less area on substrate 706 while providing higher coordinate accuracy. Furthermore, the length of the combined traces can be significantly less than the traces they replace thereby increasing bandwidth of touch sensor 700. Additionally, where a flex circuit is utilized at extremity 726a, the flex circuit can have significantly less bond pads.

Thus, as described above, various implementations of the present disclosure provide for a touch sensor having a plurality of traces situated between first and second columns of transmitter pads on a substrate. Each trace in the plurality of traces is routed from one extremity of the substrate and ends at a corresponding transmitter pad thereby creating an available area between the first and second columns of transmitter pads for one or more remaining traces of the plurality of traces. The touch sensors can have high performance characteristics while being single layer sensors and supporting multi-touch (i.e. contemporaneous touches).

From the above description it is manifested that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A touch sensor comprising:
a plurality of traces situated between first and second columns of transmitter pads on a substrate;
each trace in said plurality of traces being routed from one extremity of said substrate and ending at a corresponding transmitter pad thereby creating an available area between said first and second columns of transmitter pads for one or more remaining traces of said plurality of traces.

2. The touch sensor of claim 1, wherein for at least one trace in said plurality of traces, said one or more remaining traces has an expanded width provided by said available area.

3. The touch sensor of claim 1 comprising at least one dummy pad provided by said available area for at least one trace in said plurality of traces.

4. The touch sensor of claim 3, wherein said at least one dummy pad is situated between adjacent traces of said one or more remaining traces.

5. The touch sensor of claim 1, comprising an array arrangement of dummy pads provided by said available area for at least one trace in said plurality of traces.

6. The touch sensor of claim 1, wherein for at least one trace in said plurality of traces, each of said one or more remaining traces have an expanded insulative spacing provided by said available area.

7. The touch sensor of claim 1, comprising a ground electrode situated between and configured to insulate said plurality of traces and a neighboring receiver electrode.

8. The touch sensor of claim 7, wherein said ground electrode has an expanded width provided by said available area.

9. The touch sensor of claim 1, wherein said corresponding transmitter pad comprises sections defined by at least one branching element of a receiver electrode.

10. The touch sensor of claim 1, wherein said corresponding transmitter pad encompasses at least a portion of a receiver electrode.

11. A touch sensor comprising:
a terminating trace and one or more remaining traces situated between first and second columns of transmitter pads on a substrate;
said terminating trace being routed from one extremity of said substrate and ending at a corresponding transmitter pad thereby creating an available area between said first and second columns of transmitter pads;
wherein each of said one or more remaining traces have an expanded width provided by said available area.

12. The touch sensor of claim 11 comprising a receiver electrode having branching elements interdigitated with said first column of said transmitter pads.

13. The touch sensor of claim 11, wherein said terminating trace comprises a shielding portion configured to shield said one or more remaining traces from a receiver electrode.

14. The touch sensor of claim 11 comprising a ground electrode being routed from said one extremity of said substrate and configured to insulate said one or more remaining traces and a neighboring receiver electrode.

15. The touch sensor of claim 11, wherein said first and second columns of transmitter pads are in an array arrangement of rows and columns of transmitter pads.

16. A touch sensor comprising:
first and second pluralities of traces situated between first and second columns of transmitter pads on a substrate;
each trace in said first plurality of traces being routed from one extremity of said substrate and ending at a corresponding upper transmitter pad;
each trace in said second plurality of traces being routed from another extremity of said substrate and ending at a corresponding lower transmitter pad.

17. The touch sensor of claim 16, wherein said second plurality of traces are further routed from said one extremity to said another extremity of said substrate.

18. The touch sensor of claim 16, wherein said one extremity of said substrate is opposite to said another extremity of said substrate.

19. The touch sensor of claim 16, comprising a first portion of said second plurality of traces situated outside of said first and second columns of transmitter pads, said first portion of said second plurality of traces being more conductive than a second portion of said second plurality of traces situated between said first and second columns of transmitter pads.

20. The touch sensor of claim 16, wherein said second plurality of traces and said first and second columns of transmitter pads comprise indium tin oxide (ITO).

21. A touch sensor comprising:
a combined trace routed from one extremity of a substrate to another extremity of said substrate;
a first plurality of traces situated between first and second columns of transmitter pads on said substrate;
a second plurality of traces situated between said second column of transmitter pads and a third column of transmitter pads on said substrate;
each trace in said first and second plurality of traces being routed from said another extremity of said substrate and ending at a corresponding transmitter pad;
wherein at least one of said first plurality of traces and at least one of said second plurality of traces are coupled into said combined trace at said another extremity of said substrate.

22. The touch sensor of claim 21, wherein said corresponding transmitter pad of said at least one of said first plurality of traces and said corresponding transmitter pad of said at least one of said second plurality of traces are in a common row of transmitter pads.

23. The touch sensor of claim 21, wherein a first insulation patch is situated between said first plurality of traces and said combined trace.

24. The touch sensor of claim 23, wherein a contact portion of said at least one of said first plurality of traces extends out from under said first insulation patch to electrically connect to said combined trace.

25. The touch sensor of claim 21, wherein a second insulation patch is situated between said second plurality of traces and said combined trace.

26. The touch sensor of claim 21, wherein said at least one of said first plurality of traces has a contact portion that bends to extend substantially parallel to said combined trace.
